(19) United States
(12) Patent Application Publication
(10) Pub. No.: US 2025/0343466 A1
(43) Pub. Date: Nov. 6, 2025

(54) Green energy generation machine

(71) Applicant: Mubarak Manahi ALGHAMEDI, Mashoga (SA)

(72) Inventor: Mubarak Manahi ALGHAMEDI, Mashoga (SA)

(21) Appl. No.: 18/655,259

(22) Filed: May 5, 2024

(51) Int. Cl. H02K 7/18; F03G 3/00; F03G 3/06; F03G 3/08; H02K 7/02; H02K 7/116

(52) U.S. Cl. CPC H02K 7/1853; F03G 3/06; F03G 3/08; F03G 3/087; H02K 7/02; H02K 7/116

(57) ABSTRACT

A mechanical machine for producing clean energy that relies on a reciprocating swaying movement due to gravity.

### FIELD OF THE INVENTION

The invention is directed to a machine for producing clean energy that relies on a reciprocating swaying movement due to gravity.

### SUMMARY OF THE INVENTION

This invention relates to a mechanical machine that uses free oscillating motion by gravity to convert it into clean, free and sustainable electrical energy. The machine operates without the need to use fuel or combustion to generate energy. This machine works in any place, time and circumstance, and its stopping can be controlled from one end while it is tilting, close or remotely.

This machine is designed to achieve the highest levels of efficiency in converting movement into electrical energy, which enhances system performance, improves power generation, reduces friction, and doubles the machine's energy production.

The machine can be modified and developed according to different needs, which allows expanding the scope of power generation and adapting it to different environments and applications. This machine is somewhat similar in its movement to a children's balance seesaw (sisu) found in public parks raised by a Roman marble in the middle. It is expected that this machine will carry great benefits. It will emerge over time and will develop to currently unimaginable levels.

### BACKGROUND OF THE INVENTION

The world is witnessing an aggravating crisis in the field of energy due to the accelerating events it is going through. We find that there has been an increasing interest in securing energy needs to an increasing extent, especially electric energy, as this coincided with a noticeable decline in fossil fuel supplies, which have become difficult to rely on. Unique in providing energy needs. Although atomic energy provided a partial solution to the energy crisis, environmental problems delayed its development. Even with sufficient availability of fossil fuels.

Pollution from these types of fuels remains a serious problem. Environmental experts are making a great deal of effort to prevent the establishment of additional generating facilities that would add water, air, and thermal pollution. At the same time, new sources of energy were discovered through forms of natural forces, so the use of wind, waves and the sun as energy sources was reconsidered. There are many ways to generate energy through solar energy, many of which are now popular solar energy, but they have some disadvantages. The disadvantage is that it only works during the day under strong sunlight and stops during clouds, fog and dust. The cost of producing panels is expensive and the most expensive cost is in storing and transmitting solar energy Wind energy is the least productive and its equipment is expensive and causes noise for people living next to it. It only works when the wind passes, so it is less efficient in the summer, as is energy.

Nuclear energy produced by fossil fuels and the danger it poses to humans and the environment. This invention is the first of its kind in the field of energy and gives clean energy and it's constantly free. The force of gravity is approximately equal anywhere on the Earth's surface, and is considered a virtual constant. On the other hand, centrifugal force is infinitely variable and can be generated by rotary or repetitive movement.

The law of conservation of energy was proven and disseminated to the scientific community by Hermann Helmholtz in a series of lectures he gave in Germany in the period 1862-1863. Although Helmholtz and others since have considered many cases of force, work, energy, and motion in thermal, magnetic, electrical, and chemical particles, it is uncertain whether the implications of centrifugal force have been discovered. Specifically, the forces of attraction and centrifugal are equal and opposite but do not act on the same body and therefore do not cancel each other out. Doubling the rotation speed increases the force four times Almost all physics books/scholars in use since the 19th century try to explain impossibility of creating energy. The law of conservation of energy has not been proven conclusively. It is only an assumption because it has not been proven yet. Newton's laws agree with nature to some extent.

However, it is not all-inclusive, as Einstein explained. Newton's first law of motion: A body at rest remains at rest, and a body in motion remains in motion.

Unless some force acts on it, or it moves at a constant speed in a straight line. For movement Angle: A body that is not affected by the torque continues to remain at rest or if the rotation continues in rotation with constant angular momentum store kinetic energy for later use. For example, torque is applied by an electric motor and the kinetic energy is stored in the flywheel. Regardless of the friction, the edge will, in theory, rotate for a long time. Newton's Second Law of Motion: If a force acts on a body, it gives it an acceleration that is directly proportional to its force and inversely proportional to its mass. Regarding angular motion: the rate of change of angular momentum is equal to the applied torque.

However, the center wheel is measured at a right angle, or Perpendicular to the angular momentum and any applied or resulting torque. Newton's Third Law of Motion: “Every action force has a reaction force, equal in magnitude and opposite in direction That is, if two particles interact, the force exerted by the first particle on the second particle (called the action force) will be equal in magnitude and opposite in direction to the force that Exerted by the second particle on the first particle (called the reaction force) For angular motion: corresponding to a torque applied to one body (action), there is always An equal and opposite torque on another body (reaction). These three laws describe and allow By measuring kinetic energy and angular momentum But centrifugal force is not equal In contrast to kinetic energy, centrifugal force is a byproduct that is generated at right angles to rotational kinetic energy and angular momentum. Using pendulum torque as a way to produce work has been known for centuries. What has changed are the means of maintaining the pendulum's swing as well as the means of converting the relatively linear motion into a motion more usable for producing useful electricity.

### BRIEF DESCRIPTION OF FIGURES

In order to understand the disclosure and to see how it may be carried out in practice, embodiments will now be described, by way of non-limiting examples only, with reference to the accompanying drawings, in which:

FIG. 1 is a side view of the machine.

FIG. 2 is a front view of the machine.

FIG. 3 is a perspective view of the machine.

FIG. 4 is a pyramid wall gears.

### DETAILED DESCRIPTION OF THE INVENTION

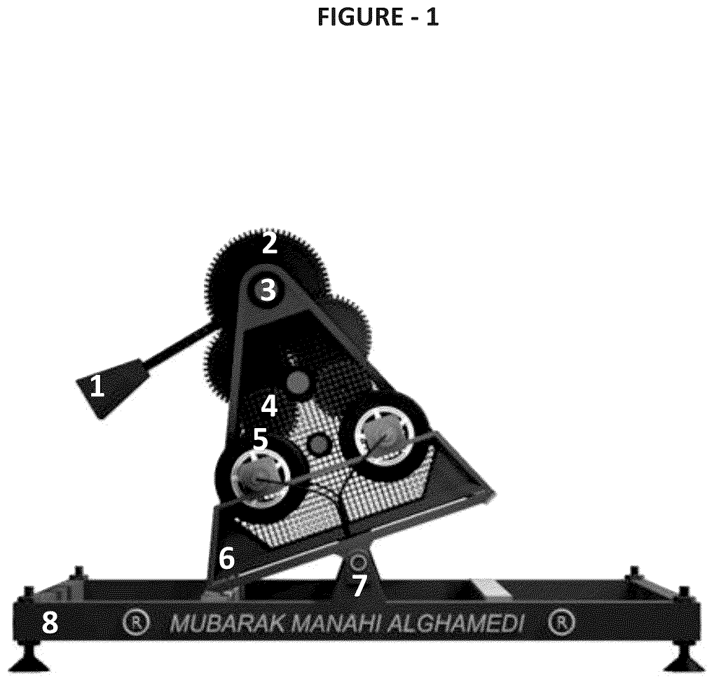

FIG. 1 is a side view of the machine. This drawing shows (1) the pendulum, where the bottom is heavier than the top and is the source of torque and movement for the machine (2) the large upper gear that drives the large and small gears beneath it and it moves in a reciprocating motion (3) the Roman ball that stabilizes the large upper gear (4) the gears Various wall pyramids to increase speed and double movement (5)

The flywheel or large solid wheel of inertia, which moves in a free movement in one direction or in a straight line to provide a strong and stable movement for the generators (6) One of the two triangles that carries all the details of the invention (7) The central Roman plate that carries the machine from the middle and is slightly raised to ensure the reciprocating sway of the machine (8) The ground base is rectangular to ensure the stability of the machine and not tip over.

Rubber, soft materials, or magnets are placed on both ends of the square carrying the machine and on the ground base to reduce the collision between them, and the machine is stopped from moving by fixing it on the end while tilting when you want to stop it from moving.

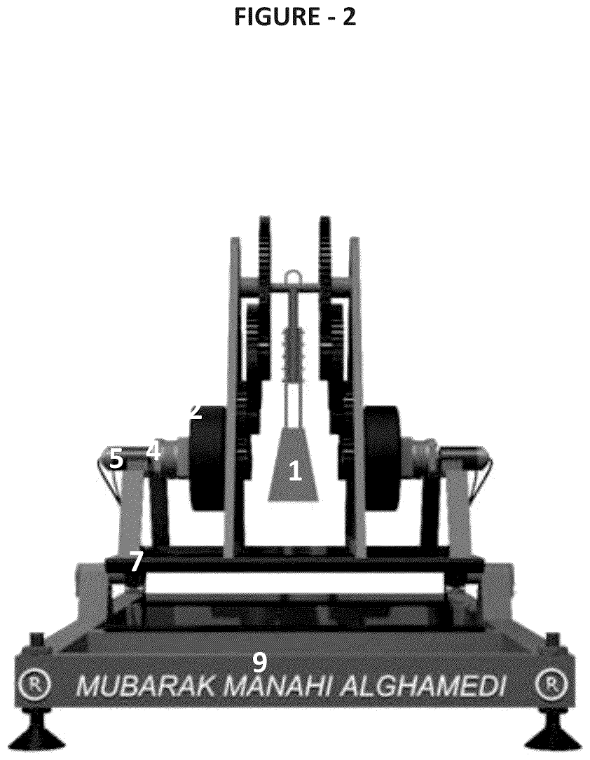

FIG. 2 is a front view of the machine. It shows (1) the pendulum in the middle at the bottom is heavier than at the top. (2) It also shows the pyramidal gears interlaced from the largest to the smallest. (3) It also shows one of the triangles carrying all the details of the invention. (4) And the solid inertia wheel that moves freely in the direction of. One, thanks to the freewheels, converts oscillating motion into free motion in one direction or in a straight line, then (5) appears.

Also the planetary gear box to double the movement and increase the speed, then (6) the power generator appears (7) the square on which the triangles and all the details of the invention are fixed (8) the zoom twists the holder of the machine in the middle and helps in covering the reciprocating oscillation (9) the rectangular floor base that carries all the details of the invention,

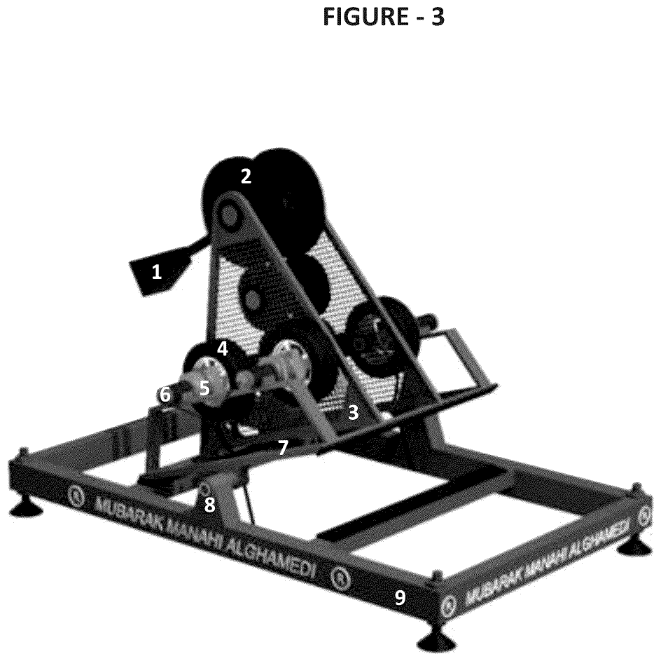

FIG. 3 is a side view of the machine. This view shows all the details of this invention, including (1) the pendulum (2), the various pyramidal wall gears (3), the triangle carrying the details of the invention, the (4) solid inertia wheels, the gear boxes (5), the planetary gear (6), the generators, and the square (7). The top on which all the details of the instrument and the Romans are composed (8) the central plate that carries the instrument from the middle and helps in the process of swaying, as well as (9) the ground base,

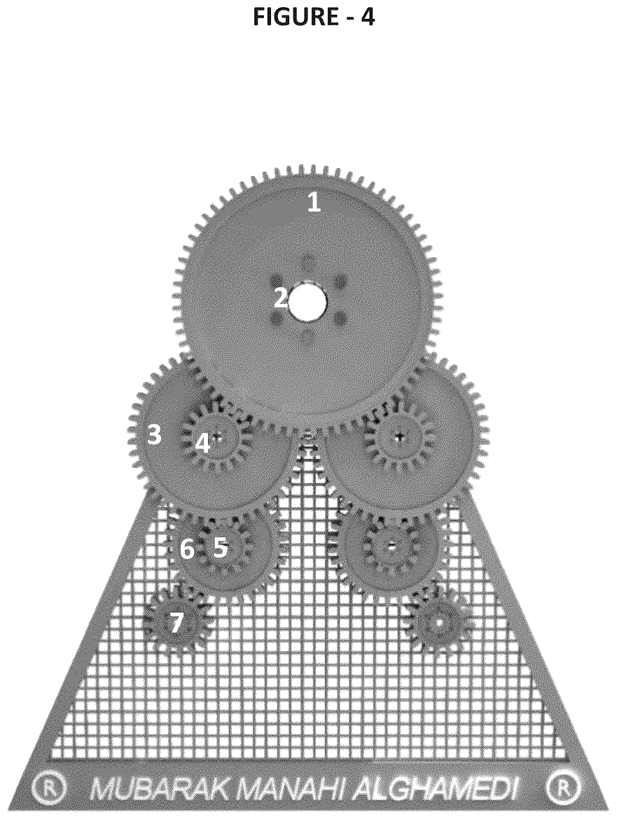

FIG. 4 is a pyramid wall gears overlapping from largest to smallest to increase movement and double speed. (1) The large upper gear, and babies can be placed directly underneath it. A large gear in which a freewheel device is placed to convert the reciprocating motion into a free motion in one direction when needed. (2) Nuts that fix the pendulum beam at the top. (3) Another large gear that moves it. (4) A small gear to maximize the movement. And increase it, and there is also (5)

A small gear to maximize and magnify the movement of the (6) medium gear, which moves in the revolution of one of the (7) small gears at the bottom. This gear contains a friol device that converts reciprocating motion into free motion in one direction so that the solid inertia wheels and planetary gear boxes move in free motion in one direction.

This is a machine that works with free reciprocating oscillation due to gravity to generate sustainable green electricity. This machine consists of two rectangles on top of each other with a short distance between them, as they are connected together by a rotating ball bearing and fixed in the middle. The rectangle above is shorter than the rectangle below, and the rectangles can be raised up for security and safety reasons This lift is then used as a warehouse of tools, batteries, and spare parts for maintenance, and two iron walls in the shape of two triangles are installed above the second rectangle above in the middle, and between them is the pendulum suspension area.

The machine contains important mechanical systems, such as freewheels that convert reciprocating motion into free movement in one direction or in a straight line, and are similar to the freewheels found in the rear wheel of a bicycle. This machine also contains toothed gears, from the two very large gears at the top to the very small gears at the bottom. The number of components of this machine can be increased or decreased according to need. The gears can be placed on the triangle called the iron wall from the inside or from the outside according to the final engineering design, and large solid wheels. Due to inertia, they are called flywheels, which contribute to maintaining the maximum levels of speed and torque. These solid wheels can be replaced with car tires with their own rims. Two wheels can be placed on either side of the machine, or four or eight wheels, four on the inside and four on the outside, to increase power production. The function of the planetary gear boxes installed in the solid rotating wheels from the outside is to increase the speed and double the movement of the generators by tens of times the movement of the flywheels. Planetary gear boxes can be installed between the pendulum and the gears. The upper one is to increase its movement, and the pendulum in the middle of the machine is fixed at the top between the two large gears, and the lower one is heavier than the upper one, which is the source of torque and movement.

The movement is connected or disconnected from the generators by stopping the machine temporarily with magnets, which are similar to the magnets of door locks and operate with electricity stored in the batteries of the machine itself at times other than peak times, or by using small switches to separate and connect the movement from the generators alternately and place them under each generator. This process is controlled by the robot or computer in the machine, which connects or disconnects the movement from the generators at specific times, stops the machine from moving or allows it to move at the specified times, measures and calculates the machine's movements using sensors, probes, and brakes, and turns it on and stops it from moving at the specified time.

The generators that produce energy are similar to those found in machines that generate energy from the passage of wind, which bear heavy work. In the middle of the machine there is a pendulum hanging below, heavier than the top, which moves the large gears at the top, moving all the gears beneath them in a reciprocating motion that does not stop unless the machine is stopped from moving. The machine also contains magnets that operate with battery electricity to stop the machine from moving at the specified time and for maintenance purposes or to insert locks into place at both ends of the machine when the rectangles touch during tilt. The machine derives its energy directly from its own movement using storage batteries. This machine can be operated manually by remote control. Near or remotely using the remote control or its application via the Internet.

1. A mechanical machine for producing clean energy that relies on a reciprocating swaying movement due to gravity.

2. The mechanical machine of claim 1 further comprising two iron rectangles horizontally on top of each other, with a short distance between them, and in the middle they are connected by a Roman ball to create a free, reciprocating sway for the upper rectangle.

3. The mechanical machine of claim 1 further comprising two triangular iron walls above the upper rectangle to install all the details of this invention above them.

4. The mechanical machine of claim 1 further comprising a pendulum suspended between the two iron walls, the bottom of which is heavier than the top, and it is the source of torque and movement for the machine.

5. The mechanical machine of claim 1 wherein the pendulum is used as a motor for gears, flywheels, planetary gearboxes, and generators, and it is in constant interaction with the movement of the machine's inclination.

6. The mechanical machine of claim 1 further comprising large gears that move small, interlocking gears in a hierarchical manner to increase the speed of flywheels, planetary gear boxes, and generators.

7. The mechanical machine of claim 1 further comprising rigid inertial flywheels, each of which moves in one direction thanks to the ferrules that convert the reciprocating motion into free motion in one direction or a straight line.

8. The mechanical machine of claim 1 wherein speed and torque depend on factors such as the distance of the inclination of the upper rectangle over the lower rectangle, the weight of the suspended pendulum, the weights of the flywheels, the sizes of the gears, the types of planetary gears, and the power generators.

9. The mechanical machine of claim 1 wherein all the details of this machine sway in a continuous free reciprocating movement due to the movement of the pendulum and its interaction with the swaying movement of the upper rectangle, and the machine is stopped at one end when it tilts.
